(19) United States
(12) Patent Application Publication
(10) Pub. No.: US 2026/0245412 A1
(43) Pub. Date: Aug. 20, 2026

(54) VEHICLE FUNCTION RECOMMENDATION SYSTEM AND METHOD

(71) Applicant: Faurecia Clarion Electronics (Xiamen) Co., Ltd., Xiamen (CN)

(72) Inventors: Qingyang SU, Xiamen (CN); Tudui HONG, Xiamen (CN); Tianjiao WANG, Xiamen (CN)

(73) Assignee: Faurecia Clarion Electronics (Xiamen) Co., Ltd., Xiamen (CN)

(21) Appl. No.: 19/534,914

(22) Filed: Feb. 10, 2026

(30) Foreign Application Priority Data
Feb. 18, 2025 (CN) 202510180213.5

(51) Int. Cl. G07C 5/08; G06F 16/28

(52) U.S. Cl. CPC G07C 5/0816; G06F 16/285

(57) ABSTRACT

The present disclosure provides a vehicle function recommendation system and method, including a data acquisition module, a learning module, a decision model and a recommendation module; the data acquisition module is configured to acquire current first information data; the learning module is configured to perform clustering analysis on historical first information data and behavior data associated with the historical first information data, to obtain historical habit data; where the historical habit data represents an association relationship between the first information data and the behavior data; the decision model is configured to determine target behavior data matched with the current first information data, based on the historical habit data; and the recommendation module is configured to determine a function recommendation result according to the target behavior data.

### CROSS-REFERENCE TO RELATED APPLICATION(S)

The present disclosure is filed based on the Chinese Patent Application with the application No. 202510180213.5, filed on February 18, 2025, and claims priority to the Chinese Patent Application, the entire content of the Chinese Patent Application is incorporated herein by reference.

### TECHNICAL FIELD

The present disclosure relates to the field of data processing technologies, and in particular to a vehicle function recommendation system and method.

### BACKGROUND

With the rapid development of intelligent driving, vehicle function recommendation systems have become an important tool to improve driving experience and enhance user satisfaction. By analyzing users’ driving habits, preferences and vehicle usage scenarios, these systems provide personalized vehicle function recommendations for users, thereby optimizing the driving process and improving driving safety and convenience.

### SUMMARY

In a first aspect, the present disclosure provides a vehicle function recommendation system, which includes: a data acquisition module, a learning module, a decision model and a recommendation module; the data acquisition module is configured to acquire current first information data; where the first information data includes at least one of state data of a vehicle, driver and passenger information, environment information of the vehicle, and data collected by a system in the vehicle; the learning module is configured to perform clustering analysis on historical first information data and behavior data associated with the historical first information data, to obtain historical habit data; where the historical habit data represents an association relationship between the first information data and the behavior data; the decision model is configured to determine target behavior data matched with the current first information data, based on the historical habit data; and the recommendation module is configured to determine a function recommendation result according to the target behavior data.

In an implementation, the learning module includes a data distribution clustering module, a first association clustering module and a second association clustering module; the data distribution clustering module is configured to perform data distribution clustering analysis on each target information item included in the historical first information data, to obtain a first cluster of each target information item; the first association clustering module is configured to perform association clustering analysis on other information items included in the historical first information data other than target information items, and the first cluster of each target information item, to obtain a second cluster; where the second cluster represents an association between different information items; and the second association clustering module is configured to perform association clustering analysis on the second cluster and the behavior data, to obtain the historical habit data.

In an implementation, the first association clustering module is configured to: analyze an association relationship between the other information items and the first cluster of each target information item, to determine a first association coefficient; where the first association coefficient is used to reflect an association degree between different information items; and in response to the first association coefficient meeting a first association condition, associate different information items corresponding to the first association coefficient with each other, to obtain the second cluster.

In an implementation, meeting the first association condition is used to represent that the first association coefficient is greater than a first threshold.

In an implementation, the second association clustering module is configured to: analyze an association relationship between the other information and the first cluster of each target information item, to determine a second association coefficient; where the second association coefficient is used to reflect an association degree between the second cluster and the behavior data; and in response to the second association coefficient meeting a second association condition, associate the second cluster corresponding to the second association coefficient with the behavior data, to obtain the historical habit data.

In an implementation, meeting the second association condition is used to represent that the second association coefficient is greater than a second threshold.

In an implementation, the decision model is configured to: determine initial behavior data matched with the current first information data based on the historical habit data; and perform a weighted operation on the initial behavior data, to obtain the target behavior data.

In an implementation, the recommendation module is further configured to judge whether enabling of a function corresponding to the function recommendation result affects driving safety of the vehicle; and the recommendation module is further configured to enable the function corresponding to the function recommendation result, in response to determining that the enabling of the function corresponding to the function recommendation result does not affect driving safety of the vehicle.

In a second aspect, the present disclosure provides a clustering analysis method, which includes: acquiring historical first information data and behavior data associated with the historical first information data; where the first information data includes at least one of state data of a vehicle, driver and passenger information, environment information of the vehicle, and data collected by a system in the vehicle; and performing clustering analysis on the historical first information data and the behavior data associated with the historical first information data, to obtain historical habit data; where the historical habit data represents an association relationship between the first information data and the behavior data.

In an implementation, performing clustering analysis on the historical first information data and the behavior data associated with the historical first information data, to obtain the historical habit data, includes: performing data distribution clustering analysis on each target information item included in the historical first information data, to obtain a first cluster of each target information item; performing association clustering analysis on other information items included in the historical first information data other than target information items, and the first cluster of each target information item, to obtain a second cluster; where the second cluster represents an association between different information items; and performing association clustering analysis on the second cluster and the behavior data, to obtain the historical habit data.

In an implementation, performing association clustering analysis on other information items included in the historical first information data other than target information items, and the first cluster of each target information item, to obtain a second cluster, includes: analyzing an association relationship between the other information items and the first cluster of each target information item, to determine a first association coefficient; where the first association coefficient is used to reflect an association degree between different information items; and in response to the first association coefficient meeting a first association condition, associating different information items corresponding to the first association coefficient with each other, to obtain the second cluster.

In an implementation, meeting the first association condition is used to represent that the first association coefficient is greater than a first threshold.

In an implementation, performing association clustering analysis on the second cluster and the behavior data, to obtain the historical habit data, includes: analyzing an association relationship between the other information and the first cluster of each target information item, to determine a second association coefficient; where the second association coefficient is used to reflect an association degree between the second cluster and the behavior data; and in response to the second association coefficient meeting a second association condition, associating the second cluster corresponding to the second association coefficient with the behavior data, to obtain the historical habit data.

In an implementation, meeting the second association condition is used to represent that the second association coefficient is greater than a second threshold.

In a third aspect, the present disclosure provides a vehicle function recommendation method, which is performed by a vehicle function recommendation system, and includes: acquiring current first information data and historical habit data; where the first information data includes at least one of state data of a vehicle, driver and passenger information, environment information of the vehicle, and data collected by a system in the vehicle; and the historical habit data represents an association relationship between the first information data and behavior data; determining target behavior data matched with the current first information data based on the historical habit data; and determining a function recommendation result according to the target behavior data.

In an implementation, determining the target behavior data matched with the current first information data based on the historical habit data, includes: determining initial behavior data matched with the current first information data based on the historical habit data; and performing a weighted operation on the initial behavior data, to obtain the target behavior data.

In an implementation, after determining the function recommendation result, the method further includes: judging whether enabling of a function corresponding to the function recommendation result affects driving safety of the vehicle based on current driving scenario information; and enabling the function corresponding to the function recommendation result, in response to determining that the enabling of the function corresponding to the function recommendation result does not affect driving safety of the vehicle.

In a fourth aspect, the present disclosure provides a vehicle, which includes the vehicle function recommendation system in the first aspect.

In a fifth aspect, the present disclosure provides an electronic device, including: a processor; and a memory configured to store instructions executable by the processor; where the processor is configured to execute the instructions to implement the clustering analysis method in the second aspect and implement the vehicle function recommendation method in the third aspect.

In a sixth aspect, the present disclosure provides a computer-readable storage medium, where instructions are stored in the computer-readable storage medium, and when the instructions are executed on a terminal, it enables the terminal to perform the clustering analysis method and the vehicle function recommendation method described in any implementation of the second aspect and the third aspect.

In a seventh aspect, the embodiments of the present disclosure provide a computer program product containing instructions, where when the computer program product is executed on an electronic device, it enables the electronic device to perform the clustering analysis method and the vehicle function recommendation method described in any implementation of the second aspect and the third aspect.

In an eighth aspect, the embodiments of the present disclosure provide a chip, which includes a processor and a communication interface, where the communication interface coupled to the processor, and the processor is configured to execute a computer program or instructions, to implement the clustering analysis method and the vehicle function recommendation method described in any implementation of the second aspect and the third aspect.

For example, the chip provided in the embodiments of the present disclosure further includes a memory for storing a computer program or instructions.

In the present disclosure, the name of the vehicle function recommendation system mentioned above does not constitute a limitation on the devices or function modules themselves. In actual implementations, these devices or function modules may appear with other names. As long as the functions of the respective devices or function modules are similar to those of the present disclosure, they fall within the scope of the claims of the present disclosure and their equivalent technologies.

These aspects or other aspects of the present disclosure will be more concise and understandable in the following description.

### BRIEF DESCRIPTION OF THE DRAWINGS

FIG. 1 is a structural schematic diagram of a vehicle function recommendation system provided in the embodiments of the present disclosure.

FIG. 2 is a schematic diagram of a hardware structure of a vehicle function recommendation system provided in the embodiments of the present disclosure.

FIG. 3 is a schematic flowchart of a clustering analysis method provided in the embodiments of the present disclosure.

FIG. 4 is a schematic diagram of first information data provided in the embodiments of the present disclosure.

FIG. 5 is a schematic flowchart of a vehicle function recommendation method provided in the embodiments of the present disclosure.

FIG. 6 is a schematic diagram of a recommendation procedure provided in the embodiments of the present disclosure.

FIG. 8 is a schematic diagram of a workflow of a vehicle function recommendation system provided in the embodiments of the present disclosure.

### DETAILED DESCRIPTION

The following is a detailed description for the vehicle function recommendation system provided in the embodiments of the present disclosure, in conjunction with the drawings.

Herein, the term "and/or" is only an association relationship describing associated objects, indicating that there may be three relationships, and for example, A and/or B, may represent three cases: only A, both A and B, and only B.

The terms "first" and "second", etc., in the description and drawings of the present disclosure are used to distinguish different objects or distinguish different processing on the same object, but not to describe a specific order of objects.

Furthermore, the terms "including/comprising" and "having" and any of their variations mentioned in the description of the present disclosure are intended to cover non-exclusive inclusion. For example, a process, method, system, product or device that contains a series of steps or units, is not limited to the listed steps or units, but in some embodiments, also includes other steps or units not listed, or in some embodiments, also includes other steps or units inherent to the process, method, product or device.

It should be noted that in the embodiments of the present disclosure, words such as "exemplary/exemplarily" or "for example", etc., are used to indicate examples, illustrations or descriptions. Any embodiment or design solution described with "exemplary/exemplarily" or "for example" in the embodiments of the present disclosure should not be construed as being more preferred or advantageous than other embodiments or design solutions. Rather, the usage of words such as "exemplary/exemplarily" or "for example", etc., is intended to present the relevant concept in a example manner.

First, some of the terms and related technologies involved in the present disclosure are explained and described, to facilitate the understanding of those skilled in the art.

Pre-trained model: the pre-trained model refers to a machine learning or deep learning model that has been pre-trained on a large-scale data set before it is formally applied to a specific task. This pre-training process is intended to enable the model to learn common features or modes in the data, so that it can adapt more quickly and improve performance when applied to the specific task subsequently.

Vehicle function recommendation system: the vehicle function recommendation system is a tool that autonomously connects a user and an object, and the vehicle function recommendation system can help the user discover interesting information in an information overload environment.

Clustering analysis: clustering analysis refers to an analysis process of grouping a set of data objects into multiple classes composed of similar objects. Clustering analysis is a technology to find an internal structure between data, by organizing all data instances into some similar groups (i.e., clusters), such that data instances in the same cluster are similar to each other and instances in different clusters are different from each other.

The above is a brief introduction to the terms involved in the embodiments of the present disclosure, which will not be repeated below.

To facilitate understanding of the technical contents of the solutions, a procedure of a vehicle function recommendation system in the related art is first introduced below.

A recommendation procedure of a reinforcement learning algorithm in a user vehicle function recommendation system generally includes the following key steps.

Initialization of the vehicle function recommendation system: set an initial state of the vehicle function recommendation system, including initializing a model parameter, defining a state space, an action space, and a reward function, etc.

Interaction of user behaviors with the environment: the user interacts with the vehicle function recommendation system through an interface, such as browsing, clicking, purchasing and other behaviors, which are fed back to the vehicle function recommendation system as the environment.

State updating and strategy selection: the vehicle function recommendation system updates a current state according to the user behavior, and selects a next content to be recommended according to the strategy. The selection of the strategy may be based on the current state, historical behaviors and information of the pre-trained model.

Performing an action and observing feedback: the vehicle function recommendation system performs a selection action, that is, recommends a content to the user, and observes feedback of the user, such as clicking, purchasing, etc.

Model updating: according to feedback parameters of the user and using these feedback parameters, update the model of the vehicle function recommendation system. Model updating may involve an adjustment strategy parameter, an optimizing value function, etc.

Loop iteration: loop iterations are performed for the above process continuously and the vehicle function recommendation system gradually learns the preferences and behavioral modes of the user, thereby providing more personalized recommendations.

However, the existing user vehicle function recommendation system generally uses reinforcement learning algorithms, which dynamically update the model in the process of users' continuous usages. However, such a method often faces the challenge of maintaining the learned user habit data when updating the model, which may lead to the instability of the recommendation result. In addition, with the increasingly rich functions of the pre-trained model, it is necessary to ensure that the system can recommend these new functions continuously and effectively after successfully learning user habit data. Therefore, how to provide high-quality recommendation services at different developed stages, and not damage the learned user habit data when updating the pre-trained model subsequently, has become a key issue to be solved urgently.

In view of the above technical deficiencies, the vehicle function recommendation system provided in the present disclosure may acquire current first information data, and perform clustering analysis on historical first information data and behavior data associated with the historical first information data, to obtain historical habit data, and determine target behavior data matched with the current first information data based on the historical habit data, and then determine a function recommendation result according to the target behavior data.

Based on this, clustering analysis is performed on the historical first information data for many times, to accurately extract the user's historical habit data, and reduce the recommendation instability caused by data noise or abnormal values. Moreover, by establishing a stable foundation of historical habit data, the present disclosure can ensure that the learned user habit data is not affected even if a new function or algorithm is introduced subsequently, thereby maintaining the continuity and stability of the recommendation. In addition, the present disclosure can analyze and determine target behavior data in the current driving scenario in real time, in conjunction with the current first information data and the historical habit data, to enable the recommendation to be more personalized and accurately reflect the current need and preference of the user.

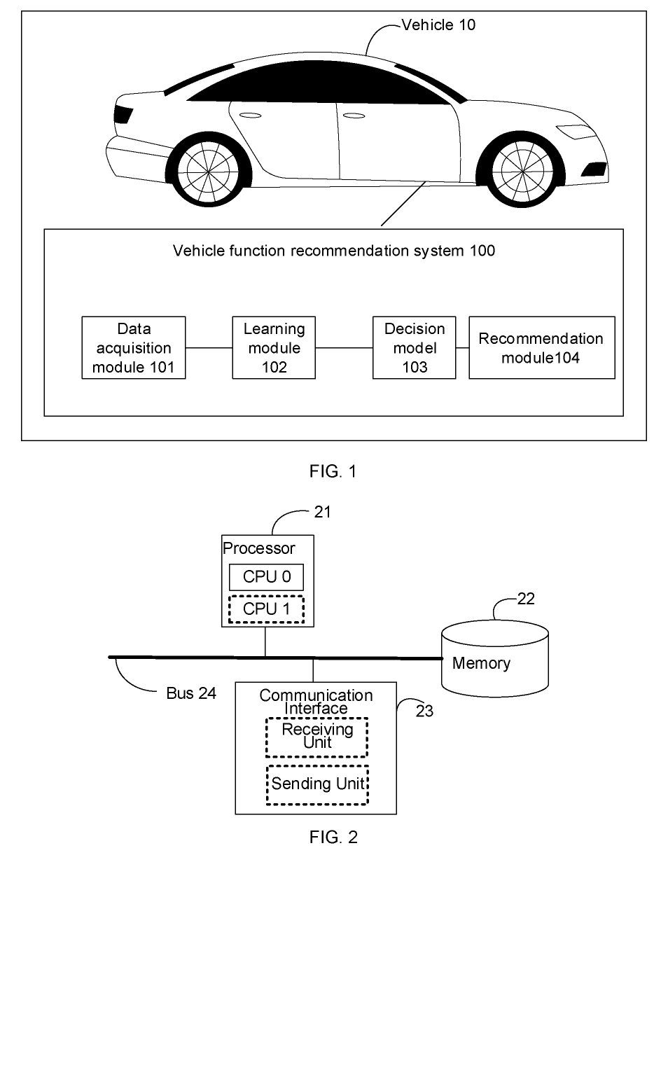

Exemplarily, as shown in FIG. 1, it is a schematic diagram of a structure of a vehicle function recommendation system 100 provided in the embodiments of the present disclosure. The vehicle function recommendation system 100 may be deployed in a vehicle 10. The vehicle function recommendation system 100 may include a data acquisition module 101, a learning module 102, a decision model 103, and a recommendation module 104.

The data acquisition module 101 may communicatively connect with the learning module 102. The data acquisition module 101 may communicatively connect with the decision model 103. The learning module 102 may communicatively connect with the decision model 103. The decision model 103 may communicatively connect with the recommendation module 104.

In some embodiments, the data acquisition module 101, the learning module 102, the decision model 103, and the recommendation module 104 in FIG. 1 may be function modules integrated within the same device or two devices that are independently set. The present disclosure does not impose any limitation thereto.

It is easily understood that in a case where the data acquisition module 101, the learning module 102, the decision model 103, and the recommendation module 104 are function modules integrated within the same device, the communication mode among the data acquisition module 101, the learning module 102, the decision model 103, and the recommendation module 104 is the communication among internal modules of the device. In this case, the communication procedure among the data acquisition module 101, the learning module 102, the decision model 103, and the recommendation module 104 is the same as “the communication procedure between two of the data acquisition module 101, the learning module 102, the decision model 103, and the recommendation module 104 that are set independently of each other”.

For ease of understanding, the present disclosure mainly takes the data acquisition module 101, the learning module 102, the decision model 103, and the recommendation module 104 being set independently of each other as an example for illustration.

The data acquisition module 101 in FIG. 1 may be configured to acquire current information data and historical information data. The learning module 102 may be configured to perform multiple clustering analyses on the historical information data based on a data type of the historical information data acquired by the data acquisition module 101, to obtain historical habit data, and store the historical habit data in a memory configured by the learning module 102. The decision model 103 may be configured to determine a current habit feature corresponding to the current information data based on the current information data and the historical habit data in the learning module 102. The recommendation module 104 is configured to determine a function recommendation result according to the current habit feature determined by the decision model.

In some embodiments, the data acquisition module 101, learning module 102, decision model 103, and recommendation module 104 in FIG. 1 may be a terminal, a server, or other types of electronic devices. FIG. 1 shows only an example of the device forms of the data acquisition module 101, the learning module 102, the decision model 103, and the recommendation module 104, and does not impose any limitation thereto.

In a case where the data acquisition module 101, learning module 102, decision model 103 and recommendation module 104 are a terminal, the terminal may be a device that provides voice and/or data connectivity to the user, a handheld device with a wireless connection function, or other processing device connected to a wireless modem. The terminal may communicate with one or more core networks via the radio access network (RAN). The terminal may be a mobile terminal, such as a computer with a mobile terminal, or it may be a portable, pocket-sized, handheld, or computer built-in mobile apparatus, that exchanges language and/or data with the wireless access network, for example, a mobile phone, a pad, a notebook, a netbook, a personal digital assistant (PDA). The present disclosure does not impose any limitation thereto.

In a case where the data acquisition module 101, learning module 102, decision model 103, and recommendation module 104 are a server, the server may be a single server, or may be a server cluster composed of multiple servers. In some implementations, the server cluster may also be a distributed cluster. The present disclosure does not impose any limitation thereto.

In an implementation, the vehicle function recommendation system 100 provided in the embodiments of the present disclosure may be applied in a vehicle. The vehicle may also be referred to as a transportation (vehicle), a mobile carrier, an electric vehicle (EV), a hybrid electric vehicle (HEV), a plug-in hybrid electric vehicle (PHEV), a fuel cell vehicle (FCV), an autonomous vehicle, an intelligent and connected vehicle (ICV), a driverless vehicle, etc.

In the embodiments of the present disclosure, the vehicle may be a sedan, a sport utility vehicle (SUV), a truck, an electric vehicle, a motorcycle, a tricycle, a special vehicle (such as an ambulance, fire engine, police car, etc.), an unmanned taxi, an intelligent connected bus, an autonomous logistics vehicle, an electric truck, etc. In addition, the method is also applicable to various special-purpose vehicles, such as agricultural vehicles, mining vehicles, forestry vehicles, airport vehicles, port vehicles, etc. The present disclosure does not impose any specific limitation thereto.

As shown in FIG. 2, it is a schematic diagram of a hardware structure of a vehicle function recommendation system provided in the embodiments of the present disclosure. The vehicle function recommendation system includes a processor 21, a memory 22, a communication interface 23, and a bus 24. The processor 21, the memory 22 and the communication interface 23 may be connected with each other through the bus 24.

The processor 21 is a control center of the vehicle function recommendation system, which may be one processor or a collective name of multiple processing elements. For example, the processor 21 may be a general-purpose central processing unit (CPU), or other general-purpose processors, etc. The general-purpose processor may be a microprocessor or any conventional processor, etc.

As an embodiment, the processor 21 may include one or more CPUs, for example, CPU 0 and CPU 1 as shown in FIG. 2.

The memory 22 may be a read-only memory (ROM) or other types of static storage devices that may store static information and instruction, a random access memory (RAM) or other types of dynamic storage devices that may store information and instruction, or an electrically erasable programmable read-only memory (EEPROM), a magnetic disk storage medium or other magnetic storage devices, or any other medium that can be used to carry or store a desired program code in the form of instructions or data structures and can be accessed by a computer, but not limited thereto.

In an implementation, the memory 22 may exist independently of the processor 21, and the memory 22 may be connected to the processor 21 via the bus 24, to store instructions or program codes. The vehicle function recommendation method provided in the following embodiments of the present disclosure can be implemented when the processor 21 calls and executes the instructions or program codes stored in the memory 22.

In another implementation, the memory 22 may also be integrated with the processor 21.

The communication interface 23 is configured such that the vehicle function recommendation system is connected to other devices through a communication network, and the communication network may be Ethernet, wireless access network, wireless local area network (WLAN), etc. The communication interface 23 may include a receiving unit for receiving data and a sending unit for sending data.

The bus 24 may be an industrial standard architecture (ISA) bus or a peripheral component interconnect (PCI) bus or an extended industry standard architecture (EISA) bus, etc. The bus may be divided into an address bus, a data bus, a control bus, etc. For ease of representation, only a thick line is used in FIG. 2 for representation, but this does not indicate that there is only one bus or one type of bus.

It should be noted that the structure shown in FIG. 2 does not constitute a limitation on the vehicle function recommendation system. In addition to the components shown in FIG. 2, the vehicle function recommendation system may include more or fewer components than those in the figure, or combine some components, or have a different component arrangement.

For ease of understanding, the following is a detailed introduction to the clustering analysis method and the vehicle function recommendation method provided in the present disclosure in conjunction with the drawings.

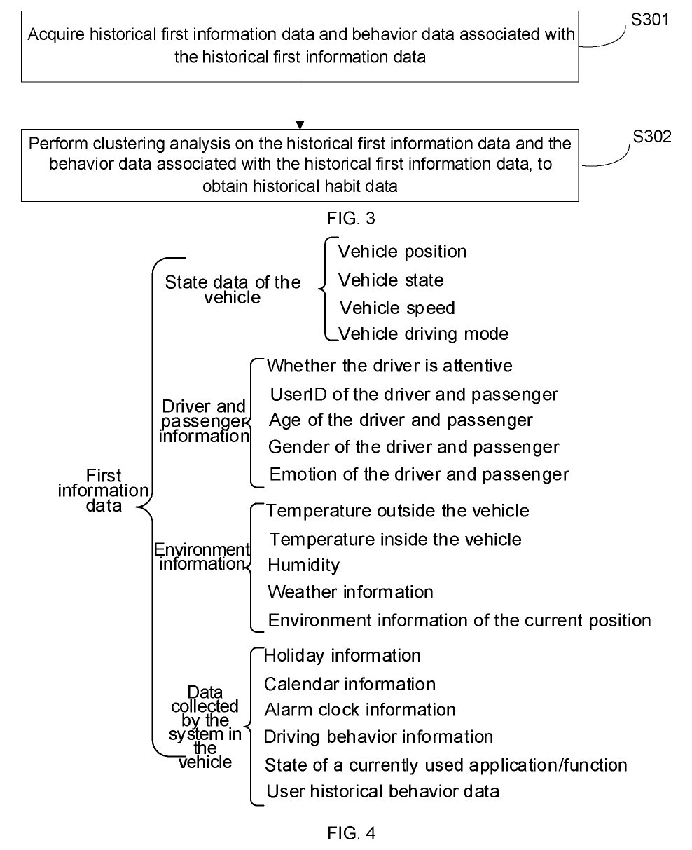

As shown in FIG. 3, it is a schematic flowchart of a clustering analysis method provided in the embodiments of the present disclosure. The clustering analysis method may be performed by the vehicle function recommendation system shown in FIG. 1. The clustering analysis method includes: S301 to S302.

S301: acquire historical first information data and behavior data associated with the historical first information data.

The historical first information data includes at least one of historical state data of the vehicle, driver and passenger information, environment information of the vehicle, and data collected by a system in the vehicle.

Exemplarily, as shown in FIG. 4, FIG. 4 is a schematic diagram of the first information data.

The state data of the vehicle includes at least one of a vehicle position, a vehicle state, a vehicle speed, and a vehicle driving mode. The driver and passenger information includes at least one of whether the driver is attentive, a user unique identifier (UserID) of the driver and passenger, an age of the driver and passenger, a gender of the driver and passenger, and an emotion of the driver and passenger. The environment information of the vehicle includes at least one of temperature outside the vehicle, temperature inside the vehicle, humidity, weather information, and environment information of the current position. The data collected by the system in the vehicle includes at least one of holiday information, calendar information, alarm clock information, driving behavior information, a state of a currently used application/function, and user historical behavior data.

Exemplarily, the historical first information data may further include:

time information: such as specific time of driving (day, night, morning and evening peak, etc.), and a season and weather condition (sunny, rainy, snowy, etc.);

geographic position: such as a route of driving, a location through the route (such as urban, rural, highway, mountain road, etc.) and a type of a road (such a main road, branch road, highway, etc.);

a vehicle state: such as vehicle speed, acceleration, braking condition, steering angle, etc.;

a driving style: such as aggressive driving (frequent acceleration, braking), conservative driving (running at a constant speed, avoiding sudden braking), etc.;

driver and passenger information: such as user ID of the driver and passenger, driving state of the driver, age of the driver and passenger, gender of the driver and passenger, emotional feature of the driver and passenger, etc.

The behavior data associated with the historical first information data includes but is not limited to that:

in a case where the historical first information data is driving in a complex road condition or an urban congestion environment, the behavior data associated with the historical first information data may be used to open a blind spot monitoring system, to improve driving safety;

in a case where the historical first information data is long distance driving or lane departure in a monotonous road condition, the behavior data associated with the historical first information data may be used to enable lane keeping aided driving and a departure warning system;

in a case where the historical first information data is a low weather state, the behavior data associated with the historical first information data may be used to enable a seat heating function or enable an air conditioning function;

in a case where the historical first information data is driving in an urban narrow road or complex road condition, the behavior data associated with the historical first information data may be used to enable a 360-degree panoramic imaging system.

In an implementation, the vehicle function recommendation system may periodically acquire the historical first information data and the behavior data associated with the historical first information data, through the configured data acquisition module.

In some embodiments, a period of the data acquisition module periodically acquiring the historical information data of the vehicle, may be set according to actual needs. For example, in the data acquisition module, three periods, i.e., a short period, a middling period, and a long period, may be set. The short period may be 1 day, the middling period may be 3 days, and the long period may be 7 days; or, the short period may be 2 days, the middling period may be 3 days, and the long period may be 5 days. The present disclosure does not impose a specific limitation thereto.

S302: perform clustering analysis on the historical first information data and the behavior data associated with the historical first information data, to obtain historical habit data.

In an implementation, the learning module may preprocess the historical first information data and the behavior data associated with the historical first information data, to clean and convert original data, thereby improving data quality and subsequent processing efficiency. The preprocessing may include data cleaning and data conversion.

The data cleaning includes processing missing values and processing abnormal values.

The processing of the missing values: the learning module may detect the historical first information data and the behavior data associated with the historical first information data, and in response to detecting that a certain input condition is missing for the historical first information data and the behavior data associated with the historical first information data, delete the input of the missing value and use a defined invalid value for padding.

The processing of the abnormal values: the learning module may process abnormal values in the historical first information data and the behavior data associated with the historical first information data, and rationalize overly large or small values in a nonlinear regression mode.

Data conversion includes but is not limited to standardization/normalization and One-hot encoding.

Standardization/normalization: to prevent certain features from having an excessive impact on the model, the learning module may use a standardization method to scale the historical information data to the same scale.

In some embodiments, the standardization method may be set according to actual needs. For example, the standardization method may be a Min-Max standardization method or a Z-score standardization method. The present disclosure does not impose a specific limitation thereto.

One-hot encoding: classified variables in the historical information data are converted into binary vectors, for use in subsequent steps.

In some embodiments, the learning module may include a data distribution clustering module, a first association clustering module, and a second association clustering module.

In an implementation, the data distribution clustering module is configured to perform data distribution clustering analysis on each target information item included in the historical first information data, to obtain a first cluster of each target information item. The first association clustering module is configured to perform association clustering analysis on other information items included in the historical first information data other than target information items, and the first cluster of each target information item, to obtain a second cluster; where the second cluster represents an association between different information items. The second association clustering module is configured to perform association clustering analysis on the second cluster and the behavior data, to obtain the historical habit data.

The implementation in which the learning module performs clustering analysis on the historical first information data and the behavior data associated with the historical first information data to obtain the historical habit data, may refer to the following S401 to S403. It will not be repeated here.

Based on the above technical solutions, the clustering analysis method provided in the present disclosure can perform multiple cluster analyses on the historical first information data, to accurately extract the user's historical habit data, thereby reducing the instability of recommendations caused by data noise or abnormal values. Thus, in the subsequent recommendation processes, the recommendations will be more personalized, which can accurately reflect the current needs and preferences of the user. Moreover, by establishing a stable foundation of historical habit data, the present disclosure can ensure that the learned user habit data is not affected even if a new function or algorithm is introduced subsequently, thereby maintaining the continuity and stability of the recommendation.

In an embodiment, in the case where multiple clustering analyses are performed on historical information data based on the data type of the historical information data to obtain the historical habit data, the clustering analysis method provided in the embodiments of the present disclosure further includes: S401 to S403.

S401: perform data distribution clustering analysis on each target information item included in the historical first information data, to obtain a first cluster of each target information item.

In some embodiments, the target information item may be pre-determined, for example, time information, position information, etc. Or, the target information item may also be non-enumerable data. The present disclosure does not impose a specific limitation thereto.

It should be noted that the non-enumerable data may be used to generally refer to data that has a vast quantity, a diverse type, and is difficult to enumerate one by one. Enumerable data may be used to represent data that has a limited quantity, an explicit type, and may be enumerated one by one.

Exemplarily, the non-enumerable data may include global positioning system (GPS) position information, time information, vehicle speed information, etc. The enumerable data may include destination information, gear information, etc.

In some embodiments, the learning module may be pre-configured with data types of the non-enumerable data and/or the enumerable data. The learning module may determine each target information item included in the historical first information data based on the pre-configured data types of the non-enumerable data and/or the enumerable data.

In an implementation, after the learning module determines each target information item included in the historical first information data, it may perform data distribution clustering analysis on each target information item included in the historical first information data, to obtain the first cluster of each target information item.

Exemplarily, the learning module may perform the first clustering analysis on GPS position information of the target information item based on a MeanShift clustering analysis algorithm, to obtain the first cluster corresponding to the GPS position information, and the first cluster corresponding to the GPS position information may be used to represent a location that the user often goes to. Alternatively, the learning module may perform the first clustering analysis on vehicle speed information of the target information item based on a k-means clustering algorithm, to obtain the first cluster corresponding to the vehicle speed information, and the first cluster corresponding to the vehicle speed information may be used to represent a frequently running speed of the vehicle speed.

It can be understood that the first cluster is a uni-dimensional cluster, including only one type of information item.

S402: perform association clustering analysis on other information items included in the historical first information data other than target information items, and the first cluster of each target information item, to obtain a second cluster.

The second cluster represents an association between different information items.

In some embodiments, in a case where the target information item is non-enumerable data, other information items included in the historical first information

data other than the target information items may be enumerable data. The present disclosure does not impose a specific limitation thereto.

In an implementation, the association relationship between other information items and the first cluster of each target information item is analyzed to determine a first association coefficient.

The first association coefficient is used to reflect an association degree between different information items.

For example, the learning module may perform feature encoding on other information items, for example, using one-hot encoding to convert class variables into numerical features. The learning module may extract a center point of each cluster and a distribution feature of data within the cluster (such as standard deviation, maximum value, minimum value, etc.) for the first cluster of each target information item, as features representing the cluster.

After the feature analysis, the learning module may use a statistical method or machine learning algorithm to analyze the first association coefficient between the enumerable data and the uni-dimensional cluster.

In some embodiments, the learning module may measure the association degree between two variables by using statistics such as chi-squared test, mutual information, correlation coefficient, etc. The present disclosure does not impose a specific limitation thereto.

In addition, for the more complex association relationship, the learning module may use an association rule mining algorithm to determine.

The learning module may determine the first association coefficient based on the result of the above analysis. The association coefficient may be direct (such as an association coefficient between a certain other information item and a certain first cluster), or indirect (such as an association coefficient determined by other variables or clusters as mediators).

In some embodiments, the first association coefficient may visually present the association between different data elements or clusters. The present disclosure does not impose a specific limitation thereto.

In an implementation, the learning module may associate different information items corresponding to the first association coefficient with each other to obtain a second cluster, in response to the first association coefficient meeting a first association condition.

Meeting the first association condition is used to represent that the first association coefficient is greater than a first threshold.

In some embodiments, the first threshold may be set according to the actual needs. For example, the first threshold may be 80% or 90%. The present disclosure does not impose a specific limitation thereto.

Exemplarily, the learning module may perform a second clustering analysis on GPS information (home, company, and frequently visited position, that are clustered) and time information (going to work in the morning, coming home in the afternoon, and going to the gym on weekends, that are clustered), as well as not going to the company during holidays, to obtain the corresponding second cluster.

S403: perform association clustering analysis on the second cluster and the behavior data, to obtain the historical habit data.

In an implementation, the learning module may analyze the association relationship between other information items and the first cluster of each target information item, to determine a second association coefficient.

The second association coefficient is used to reflect an association degree between the second cluster and the behavior data.

It can be understood that the method for determining the second association coefficient by the learning module may refer to the method of determining the first association coefficient by the learning module in the above S402, and will not be repeated here.

In an implementation, the learning module may associate the second cluster corresponding to the second association coefficient with the behavior data, to obtain the historical habit data, in response to the second association coefficient meeting a second association condition.

Meeting the second association condition is used to represent that the second association coefficient is greater than a second threshold.

In some embodiments, the second threshold may be set according to the actual needs. For example, the second threshold may be 80% or 90%. The present disclosure does not impose a specific limitation thereto.

Based on this, the present disclosure performs data distribution clustering analysis on each target information item in the historical first information data, which may clearly reveal the distribution features of these data items, and furthermore, performs association clustering analysis on the first cluster of the target information item and other information items, and performs association clustering analysis on the second cluster and the behavior data, to determine the association relationship between different information items and how the association relationship affects the behavior data. Thus, the subsequent recommendation results can accurately reflect the current needs and preferences of the user.

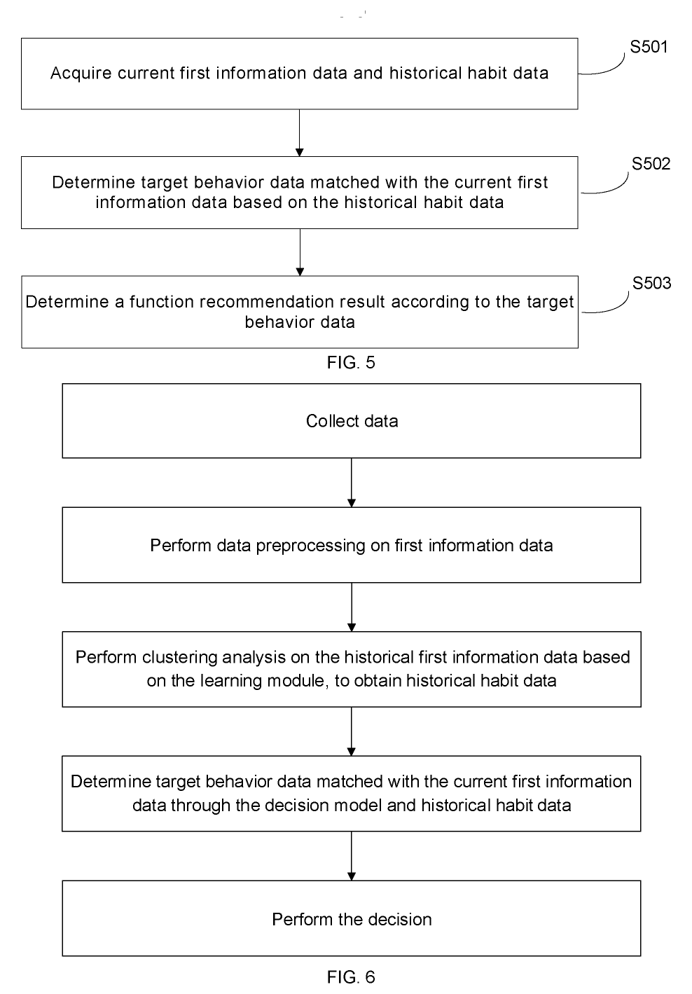

In an embodiment, as shown in FIG. 5, the vehicle function recommendation method provided in the embodiments of the present disclosure includes: S501 to S503.

S501, acquire current first information data and historical habit data.

In an implementation, the historical habit data may be stored in a memory configured by the learning module. The data acquisition module may acquire the historical habit data from the memory configured by the learning module. The data acquisition module may also acquire the current first information data based on a current car usage situation.

It can be understood that the determination method of the historical habit data may refer to the description of the above S301 to S302 and the above S401 to S403, which will not be repeated here.

S502, determine target behavior data matched with the current first information data based on the historical habit data.

In an implementation, the decision model may determine initial behavior data matched with the current first information data based on the historical habit data.

Exemplarily, if it is a weekend afternoon and the driver is driving on the highway currently, the matched initial habit feature may include that "play music when driving at high speed on the weekend", "prefer relaxing music during the afternoon", "the driver often uses the autonomous driving assistance system to reduce the burden of driving when driving long distances on highways", etc.

For another example, if both the driver and passenger are irritated on an urban congested road, the matched initial behavior data may include that "prefer to listen to soothing music to relieve stress in the urban congestion", "like to use a real-time traffic condition prompt function of the in-vehicle navigation in a congested road", etc.

In an implementation, the decision model may perform a weighted operation on the initial behavior data to obtain the target behavior data.

For example, the decision model may allocate a weight to each matched initial behavior data. The allocation of the weight may be based on many factors, such as the frequency of occurrence of historical habits, the time correlation, the correlation of the driving scenario, and the urgency of the behavior intention of the people in the vehicle, etc.

Exemplarily, if a feature "playing music when driving at a high speed on weekends" has occurred frequently in the past few months and is highly relevant to the current driving scenario, the feature may be assigned a high weight.

Then, the decision model may calculate the target behavior data by using a weighted operation and/or other operation methods, in conjunction with weights of all matched initial behavior data.

Exemplarily, if the initial behavior data "prefer to listen to a soothing music to relieve stress in the urban congestion" has a weight of 0.8, and "like to use a real-time traffic condition prompt function of the in-vehicle navigation in a congested road" has a weight of 0.2, etc., the decision model may perform the weighted operation to obtain the current habit feature as: listening to a soothing music and providing a real-time traffic condition prompt, and the music volume being relatively loud and the real-time traffic condition prompt volume being relatively low.

S503: determine a function recommendation result according to the target behavior data.

Exemplarily, the function recommendation result corresponds to the target behavior data, and if the target behavior data are listening to a soothing music and providing a real-time traffic condition prompt, and the music volume being relatively loud and the real-time traffic condition prompt volume being relatively low, the recommendation module may determine that the function recommendation result is to open the music player and the navigation system, and make the music playing volume louder than the navigation system volume.

In an implementation, the recommendation module may judge whether enabling of a function corresponding to the function recommendation result affects driving safety of the vehicle, based on the current driving scenario information, and in response to determining that the enabling of the function corresponding to the function recommendation result does not affect driving safety of the vehicle, enable the function corresponding to the function recommendation result.

Exemplarily, in a case where the function recommendation result is autonomous driving, the recommendation module may determine whether enabling of autonomous driving adversely affects the driving safety of the vehicle, based on the current driving scenario information. The recommendation module may determine that the enabling of the autonomous driving at this moment may affect the driving safety of the vehicle, in a case of determining that lane markings cannot be identified and a high-definition map has not been matched based on the current driving scenario information. The recommendation module may not enable autonomous driving in a case of determining that the enabling of the autonomous driving may affect driving safety of the vehicle, otherwise, it enables the autonomous driving.

Based on the above technical solutions, the present disclosure may analyze and determine the target behavior data in the current driving scenario in real time, in conjunction with the current first information data and the historical habit data, enabling the recommendation to accurately reflect the current needs and preferences of the user.

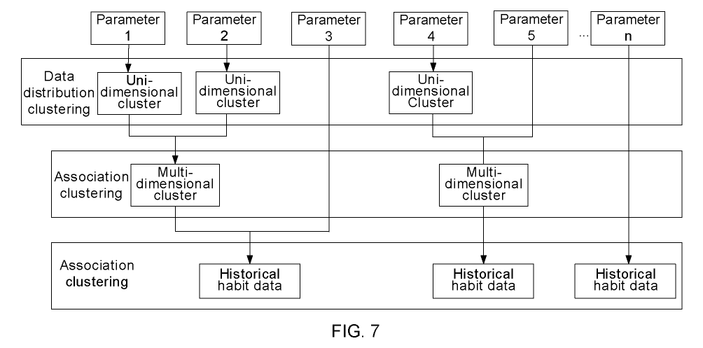

In an embodiment, as shown in FIG. 6, it is a schematic diagram of a recommendation procedure.

In an implementation, the vehicle function recommendation system may collect data, that is, the vehicle function recommendation system may collect current first information data and historical first information data. The vehicle function recommendation system may perform data preprocessing on the first information data.

The vehicle function recommendation system may perform clustering analysis on the historical first information data based on the learning module, to obtain historical habit data. The vehicle function recommendation system may determine target behavior data matched with the current first information data through the decision model and historical habit data, that is, the vehicle function recommendation system may generate first behavior data through the decision model and the current first information data, and according to the historical habit data and the current first information data, generate second behavior data, and furthermore, perform a weighted operation on the first behavior data and the second behavior data, to determine the target behavior data matched with the current first information data. The vehicle function recommendation system may perform the decision, that is, determine the function recommendation result according to the target behavior data.

In an embodiment, as shown in FIG. 7, it is a schematic diagram of another recommendation procedure.

Exemplarily, the historical first information data includes a parameter 1, a parameter 2, a parameter 3, a parameter 4, a parameter 5, and a parameter n.

The learning module may determine the parameter 1, parameter 2, and parameter 4 as the target information items, and then perform data distribution clustering analysis on the parameter 1, parameter 2, and parameter 4 to obtain uni-dimensional clusters corresponding to the parameter 1, parameter 2, and parameter 4 respectively. The learning module may perform association clustering analysis based on the uni-dimensional clusters corresponding to the parameter 1, parameter 2, and parameter 4 respectively, and other parameters, to obtain a multi-dimensional cluster. The learning module may perform association clustering analysis based on the multi-dimensional cluster and parameters, to obtain final historical habit data.

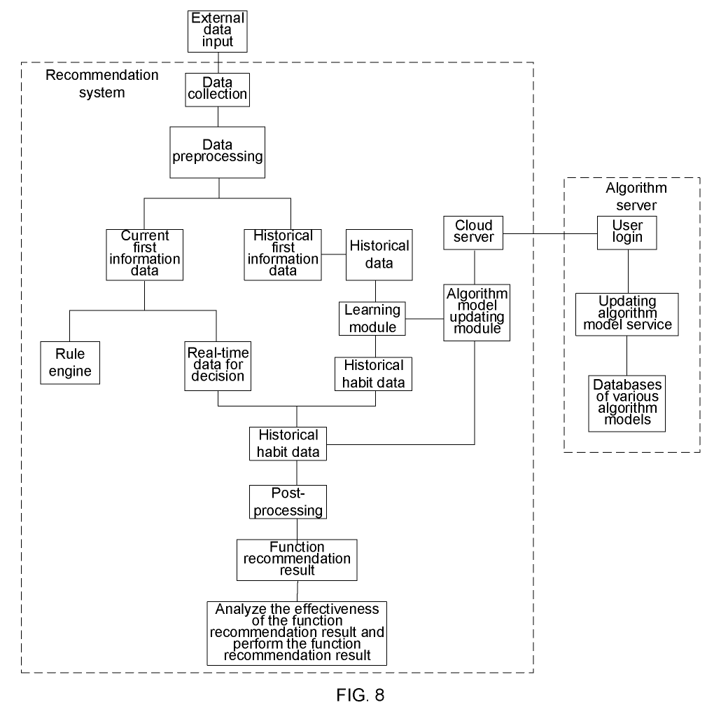

In an embodiment, as shown in FIG. 8, it is a schematic diagram of a workflow of a vehicle function recommendation system, and the recommendation procedure is applied to the vehicle function recommendation system.

The vehicle function recommendation system may receive external data input and complete data collection, that is, the vehicle function recommendation system may collect the current first information data. The vehicle function recommendation system may perform data preprocessing on the first information data. The vehicle function recommendation system may forward the cleaned current first information data to a rule engine and real-time data for decision based on routing. The vehicle function recommendation system may store the cleaned current first information data, to obtain historical data. The vehicle function recommendation system may acquire the historical first information data from the historical data based on the learning module, and perform clustering analysis on the historical first information data to obtain the historical habit data. The vehicle function recommendation system may acquire the current first information data and the historical habit data based on the decision model, and perform post-processing in conjunction with the rule engine, to obtain the function recommendation result. The vehicle function recommendation system may analyze the effectiveness of the function recommendation result and perform the function recommendation result.

In addition, the vehicle function recommendation system may also include an algorithm model updating module. The vehicle function recommendation system may update the learning module and the decision model through the algorithm model updating module.

The vehicle function recommendation system may enable user login through a cloud server to enter an algorithm server. The algorithm server may include an updating algorithm model service, and databases of various algorithm models.

Through the above description of the implementations, technicians in the related art may clearly understand that the division of the above-mentioned function modules is illustrated as an example only, for the convenience and conciseness of the description, and in practical applications, the above-mentioned functions may be allocated and completed by different function modules according to needs, that is, the internal structure of the apparatus is divided into different function modules, to complete all or some of the functions described above. The operation process of the system, apparatus and units described above may refer to the corresponding process in the aforementioned method embodiments, and will not be repeated here.

The embodiments of the present disclosure provide a computer program product including instructions, and when the computer program product is running on a computer, it enables the computer to perform the clustering analysis method and the vehicle function recommendation method in the above-mentioned method embodiments.

The embodiments of the present disclosure also provide a computer-readable storage medium in which instructions are stored, and when the instructions are running on a computer, they enable the computer to perform the clustering analysis method and the vehicle function recommendation method in the method flow shown in the above-mentioned method embodiments.

The computer-readable storage medium, for example, may be but is not limited to electrical, magnetic, optical, electromagnetic, infrared, or semiconductor systems, apparatuses or devices, or any combination thereof. More specific examples (not an exhaustive list) of computer readable storage medium include: an electrical connection with one or more wires, a portable computer disk, a hard disk, a random access memory (RAM), a read-only memory (ROM), an erasable programmable read only memory (EPROM), a register, a hard disk, an optical fiber, a compact disc read-only memory (CD-ROM), an optical storage device, a magnetic storage device, or any suitable combination thereof, or any other form of computer readable storage medium as well known in the art. An exemplary storage medium is coupled to a processor, thereby enabling the processor to read information from the storage medium and write information to the storage medium. Of course, the storage medium may also be a component of the processor. The processor and the storage medium may be located in an application specific integrated circuit (ASIC). In the embodiments of the present disclosure, the computer-readable storage medium may be any tangible medium including or storing a program, which may be used by or used in conjunction with an instruction execution system, apparatus or device.

Since the vehicle function recommendation system, the computer-readable storage medium and the computer program product in the embodiments of the present disclosure may be applied to the above methods, the technical effects that can be obtained by them may also refer to the above-mentioned method embodiments, and will not be repeated in the embodiments of the present disclosure.

The above is only the implementations of the present disclosure, but the scope of protection of the present disclosure is not limited thereto, and any change or replacement within the technical scope disclosed in the present disclosure should be covered within the scope of protection of the present disclosure. Therefore, the scope of protection of the present disclosure should be determined based on the scope of protection of the claims.

What is claimed is:

1. A vehicle function recommendation system, wherein the system comprises a data acquisition module, a learning module, a decision model and a recommendation module;
the data acquisition module is configured to acquire current first information data; wherein the first information data comprises at least one of state data of a vehicle, driver and passenger information, environment information of the vehicle, and data collected by a system in the vehicle;
the learning module is configured to perform clustering analysis on historical first information data and behavior data associated with the historical first information data, to obtain historical habit data; wherein the historical habit data represents an association relationship between the first information data and the behavior data;
the decision model is configured to determine target behavior data matched with the current first information data, based on the historical habit data; and
the recommendation module is configured to determine a function recommendation result according to the target behavior data.

2. The system according to claim 1, wherein the learning module comprises a data distribution clustering module, a first association clustering module and a second association clustering module;
the data distribution clustering module is configured to perform data distribution clustering analysis on each target information item comprised in the historical first information data, to obtain a first cluster of each target information item;
the first association clustering module is configured to perform association clustering analysis on other information items comprised in the historical first information data other than target information items, and the first cluster of each target information item, to obtain a second cluster; wherein the second cluster represents an association between different information items; and
the second association clustering module is configured to perform association clustering analysis on the second cluster and the behavior data, to obtain the historical habit data.

3. The system according to claim 2, wherein
the first association clustering module is configured to:
analyze an association relationship between the other information items and the first cluster of each target information item, to determine a first association coefficient; wherein the first association coefficient is used to reflect an association degree between different information items; and
in response to the first association coefficient meeting a first association condition, associate different information items corresponding to the first association coefficient with each other, to obtain the second cluster.

4. The system according to claim 3, wherein
meeting the first association condition is used to represent that the first association coefficient is greater than a first threshold.

5. The system according to claim 2, wherein
the second association clustering module is configured to:
analyze an association relationship between the other information and the first cluster of each target information item, to determine a second association coefficient; wherein the second association coefficient is used to reflect an association degree between the second cluster and the behavior data; and
in response to the second association coefficient meeting a second association condition, associate the second cluster corresponding to the second association coefficient with the behavior data, to obtain the historical habit data.

6. The system according to claim 5, wherein
meeting the second association condition is used to represent that the second association coefficient is greater than a second threshold.

7. The system according to claim 1, wherein
the decision model is configured to:
determine initial behavior data matched with the current first information data based on the historical habit data; and
perform a weighted operation on the initial behavior data, to obtain the target behavior data.

8. The system according to claim 2, wherein
the decision model is configured to:
determine initial behavior data matched with the current first information data based on the historical habit data; and
perform a weighted operation on the initial behavior data, to obtain the target behavior data.

9. The system according to claim 3, wherein
the decision model is configured to:
determine initial behavior data matched with the current first information data based on the historical habit data; and
perform a weighted operation on the initial behavior data, to obtain the target behavior data.

10. The system according to claim 4, wherein
the decision model is configured to:
determine initial behavior data matched with the current first information data based on the historical habit data; and
perform a weighted operation on the initial behavior data, to obtain the target behavior data.

11. The system according to claim 7, wherein
the recommendation module is further configured to judge whether enabling of a function corresponding to the function recommendation result affects driving safety of the vehicle; and
the recommendation module is further configured to enable the function corresponding to the function recommendation result, in response to determining that the enabling of the function corresponding to the function recommendation result does not affect driving safety of the vehicle.

12. A clustering analysis method, performed by a vehicle function recommendation system, and comprising:
acquiring historical first information data and behavior data associated with the historical first information data; wherein the first information data comprises at least one of state data of a vehicle, driver and passenger information, environment information of the vehicle, and data collected by a system in the vehicle; and
performing clustering analysis on the historical first information data and the behavior data associated with the historical first information data, to obtain historical habit data; wherein the historical habit data represents an association relationship between the first information data and the behavior data.

13. The method according to claim 12, wherein performing clustering analysis on the historical first information data and the behavior data associated with the historical first information data, to obtain the historical habit data, comprises:
performing data distribution clustering analysis on each target information item comprised in the historical first information data, to obtain a first cluster of each target information item;
performing association clustering analysis on other information items comprised in the historical first information data other than target information items, and the first cluster of each target information item, to obtain a second cluster; wherein the second cluster represents an association between different information items; and
performing association clustering analysis on the second cluster and the behavior data, to obtain the historical habit data.

14. The method according to claim 13, wherein performing association clustering analysis on other information items comprised in the historical first information data other than target information items, and the first cluster of each target information item, to obtain a second cluster, comprises:
analyzing an association relationship between the other information items and the first cluster of each target information item, to determine a first association coefficient; wherein the first association coefficient is used to reflect an association degree between different information items; and
in response to the first association coefficient meeting a first association condition, associating different information items corresponding to the first association coefficient with each other, to obtain the second cluster.

15. The method according to claim 14, wherein
meeting the first association condition is used to represent that the first association coefficient is greater than a first threshold.

16. The method according to claim 13, wherein performing association clustering analysis on the second cluster and the behavior data, to obtain the historical habit data, comprises:
analyzing an association relationship between the other information and the first cluster of each target information item, to determine a second association coefficient; wherein the second association coefficient is used to reflect an association degree between the second cluster and the behavior data; and
in response to the second association coefficient meeting a second association condition, associating the second cluster corresponding to the second association coefficient with the behavior data, to obtain the historical habit data.

17. The method according to claim 16, wherein
meeting the second association condition is used to represent that the second association coefficient is greater than a second threshold.

18. A vehicle function recommendation method, performed by a vehicle function recommendation system, and comprising:
acquiring current first information data and historical habit data; wherein the first information data comprises at least one of state data of a vehicle, driver and passenger information, environment information of the vehicle, and data collected by a system in the vehicle; and the historical habit data represents an association relationship between the first information data and behavior data;
determining target behavior data matched with the current first information data based on the historical habit data; and
determining a function recommendation result according to the target behavior data.

19. The method according to claim 18, wherein determining the target behavior data matched with the current first information data based on the historical habit data, comprises:
determining initial behavior data matched with the current first information data based on the historical habit data; and
performing a weighted operation on the initial behavior data, to obtain the target behavior data.

20. The method according to claim 18, wherein after determining the function recommendation result, the method further comprises:
judging whether enabling of a function corresponding to the function recommendation result affects driving safety of the vehicle based on current driving scenario information; and
enabling the function corresponding to the function recommendation result, in response to determining that the enabling of the function corresponding to the function recommendation result does not affect driving safety of the vehicle.
